(19) United States
(12) Patent Application Publication
(10) Pub. No.: US 2010/0250253 A1
(43) Pub. Date: Sep. 30, 2010

(54) CONTEXT AWARE, SPEECH-CONTROLLED INTERFACE AND SYSTEM

(76) Inventor: Yangmin Shen, Peoria, IL (US)

Correspondence Address: WOOD, HERRON & EVANS, LLP, 2700 CAREW TOWER, 441 VINE STREET, CINCINNATI, OH, 45202, US

(21) Appl. No.: 12/412,789

(22) Filed: Mar. 27, 2009

(51) Int. Cl. G10L 13/08; G10L 21/00

(52) U.S. Cl. 704/260; 704/275; 704/E21.019; 704/E13.011

(57) ABSTRACT

A speech-directed user interface system includes at least one speaker for delivering an audio signal to a user and at least one microphone for capturing speech utterances of a user. An interface device interfaces with the speaker and microphone and provides a plurality of audio signals to the speaker to be heard by the user. A control circuit is operably coupled with the interface device and is configured for selecting at least one of the plurality of audio signals as a foreground audio signal for delivery to the user through the speaker. The control circuit is operable for recognizing speech utterances of a user and using the recognized speech utterances to control the selection of the foreground audio signal.

### FIELD OF THE INVENTION

This invention relates generally to the control of multiple audio and data streams, and particularly it relates to the utilization of user speech to interface with various sources of such audio and data.

### BACKGROUND OF THE INVENTION

The concept of multi-tasking is very prevalent in today's work environment, wherein a person interfaces with various different people, computers, and devices, sometimes simultaneously. The multiple sources of communication and data can be difficult to manage. Usually, a person is required to juggle various different input streams, such as audio signals and communication streams, as well as data input.

For example, a public safety worker, or police officer might have to interface with various different radios, such as two-way radio communication to other persons, a dispatch radio, and a GPS unit audio source, such as in a vehicle. Furthermore, they may have to interface with various different databases, which may include local law enforcement databases, state/federal law enforcement databases, or other emergency databases, such as for emergency medical care.

Currently, the various different audio sources and computer sources are stand-alone systems, and generally have their own dedicated input and output devices, such as a microphone and speaker for each audio source, and a mouse or keyboard for various database sources.

When there are multiple audio sources, such as communication links to other personnel or to various different locations, it often becomes difficult for a listener to distinguish between the various audio sources and to prioritize such sources, even though the person desires to hear all the audio input. Similarly, access to various different databases or applications may require juggling back and forth between different computer devices or applications.

Accordingly, there is a need in the art for a way in which to control and organize the various audio and data inputs that a person may utilize in a multitasking environment. There is further a need to prioritize and handle multiple audio sources to minimize confusion of a listener. There is still further a need to consolidate and control disjointed audio sources and applications, and thus, reduce mental confusion and the physical clutter associated with individual dedicated devices. Such needs are addressed and other advantages provided by the present invention as described further herein.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a schematic view of a person utilizing various different audio and data devices.

FIG. 2 is a schematic block diagram of an embodiment of the present invention.

FIG. 3 is a schematic block diagram of an embodiment of the present invention.

### DETAILED DESCRIPTION OF EMBODIMENTS OF THE INVENTION

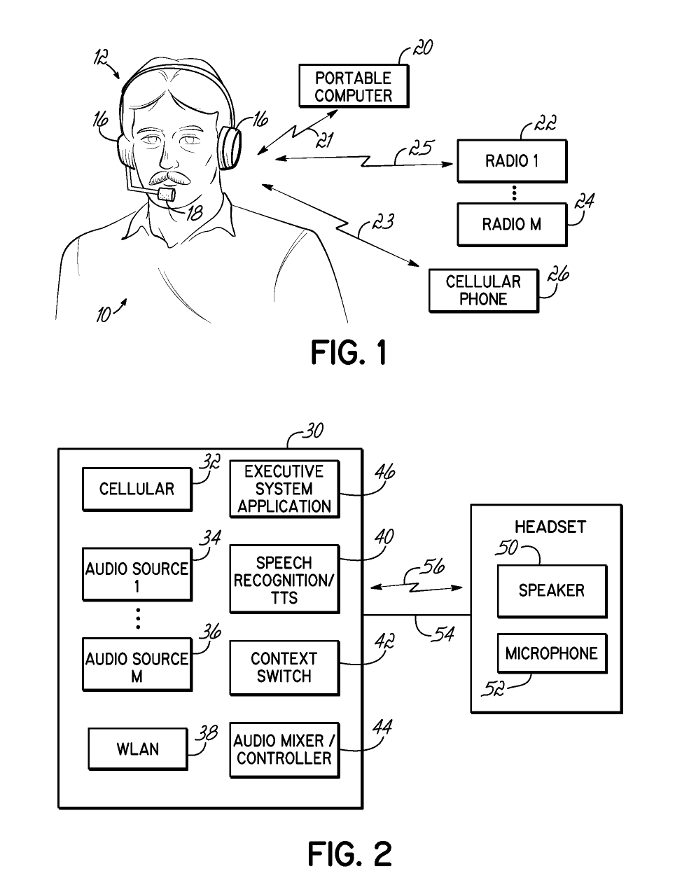

FIG. 1 illustrates a potential user with an embodiment of the invention, and shows a person or user 10, which may interface with one or more data or audio devices simultaneously for performing a particular task or series of tasks where input from various sources and output to various sources is necessary. For example, user 10 might interface with one or more portable computers 20 (e.g., laptop or PDA), radio devices 22, 24, or a cellular phone 26. While a portable computer 20 may include various input devices, such as a keyboard or a mouse, the user 10 may interface with the radios or a cellular phone utilizing appropriate speakers and microphones on the radios or phone units. The present invention provides a way to interface with all of the elements of FIG. 1 using human speech.

As illustrated in FIG. 1, one possible environment or element for implementing the present invention is with a headset 12 worn by a user and operable to provide a context-aware, speech-controlled interface. Speakers 16 and microphone 18 might be incorporated into headset 12. Some other suitable arrangement might also be used. The cab of a vehicle might be another environment for practicing the invention. A sound booth or room where sound direction and volume might be controlled is another environment. Basically, any environment where direction/volume and other aspects of sound might be controlled in accordance with the invention would be suitable for practicing the invention. For example, speakers might be incorporated into an earpiece that is placed into or proximate the user's ear, but the microphone might be carried separately by the user. Accordingly, the layout of such speaker and microphone components and how they are carried or worn by the user or mounted within another environment is not limiting to this invention.

Generally, in accordance with one aspect of the present invention, voice is utilized by a user, and particularly user speech is utilized, to control and interface with one or more components, as illustrated in FIG. 1, or with a single component, which interfaces with multiple sources, as discussed herein with respect to one embodiment of the invention.

FIG. 2 illustrates a possible embodiment of the invention, wherein multiple sources of audio streams or data streams are incorporated into a single interface device 30 that may be carried by a user. Alternatively, another embodiment of the invention might provide an interface to various different stand-alone components, as illustrated in FIG. 1. As such, the present invention is not limited by FIG. 2, which shows various audio and data input/output devices consolidated into a single device 30.

The interface device 30 might include the necessary electronic components (hardware and software) to operate within a cellular network. For example, the device 30 could have the functionality to act as a cellular phone or personal data assistant (PDA). The necessary cellular components for affecting such operability for device 30 are noted by reference numeral 32. Device 30 might also incorporate one or more radios or audio sources, such as audio source 1, (34), up to audio source M(36). Each of those radios or audio sources 34, 36 might provide connectivity for device 30 to various other different audio sources. For example, with a public safety worker/police officer, one radio component of device 30 might provide interconnectivity to another worker or officer, such as in a two-way radio format. Similarly, the radio 36 might provide interconnectivity to another audio source, such as a dispatch center.

Device 30 also includes the functionality (hardware and software) to interconnect with one or more data sources. For example, device 30 might include the necessary (hardware and software) components 38 for coupling to a networked computer or server through an appropriate wireless or wired network, such as a WLAN network. The device 30 also includes various other functional components and features, which are appropriately implemented in hardware and software.

For example, device 30 incorporates a speech recognition/TTS (text-to-speech) functionality 40 in accordance with one aspect of the present invention for capturing speech from a user, and utilizing that speech to provide the speech interface and control of the various audio streams and data streams and audio and data sources that are managed utilizing the present invention. A context switch 42 is also provided, and is utilized to control where speech from the user is directed. An audio mixer/controller component 44 is also provided in order to control the input flow and priority of audio streams and data streams from various different external sources. To that end, an executive application 46 monitors, detects and responds to key words/phrase commands in order to control the input flow of audio and data to a user, such as through device 30, and also to control the output flow of audio to a particular destination device or system.

To implement the speech control of the present invention, a speaker 50 and microphone 52, which are worn or otherwise utilized by a user are appropriately coupled to device 30, either with a wired link 54, or an appropriate wireless link 56. The wireless link may be a short-range or personal area network link (WPAN) as device 30 would generally be carried or worn by a user or at least in the near proximity to the user. To implement a speaker and microphone, a headset 58 might be utilized and worn by a user. Headset 58 might, for example, resemble the headset 12, as illustrated in FIG. 1, wherein the speaker and microphone are appropriately placed on the head. As noted above, while the embodiment of the invention illustrated in FIG. 2 uses a single device for implementing the functionality for various different audio and data interfaces, multiple individual devices might also benefit from the interface provided by the present invention.

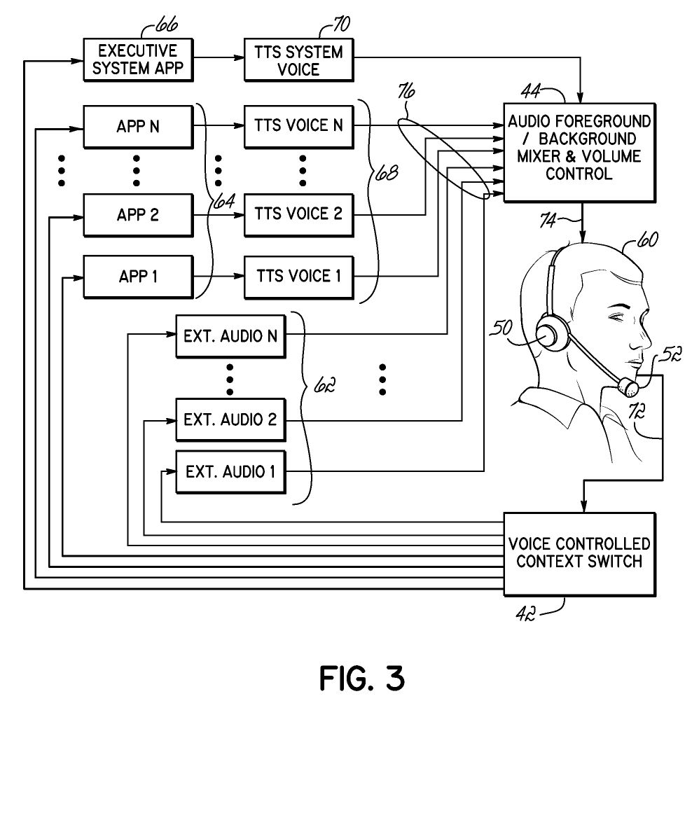

FIG. 3 illustrates a conceptual block diagram illustrating the operation of an embodiment of the present invention. A user 60 is shown interfacing with various different external audio sources 62, various different data applications 64, and at least one executive system application 66 for providing the desired control in the invention, based upon the speech of the user 60. Each of the external audio sources 62 will provide the audio streams associated with their particular sources and uses. Generally, those external audio sources may also be reflective of a destination for the speech of the user, as discussed further hereinbelow. As such, the external audio sources may represent a two-way audio or speech dialog.

The various data applications 64 interface with user 60 utilizing voice or speech. Particularly, the application data is converted to speech utilizing respective text-to-speech (TTS) functionalities for each application 64, as illustrated by reference numeral 68. In that way, the data applications are configured to receive data inputs associated with user speech and also provide a synthesized speech output. The executive system application 66 also utilizes its own TTS functionalities indicated by reference numeral 70. As noted in FIG. 2, each of the external audio sources 62 might come from a separate, stand-alone device, such as from various different radios, for example. Similarly, the data applications 64 might also be associated with various different data applications. For example, application 1 might be run on a laptop computer, whereas application 2 might be run on a personal data assistant (PDA) carried by a user. As such, the present invention might be implemented on a device or in an environment that then interfaces with the stand-alone radios or computers to provide the speech interface and context control of the invention.

In another embodiment of the invention, as illustrated in FIG. 2, all of the functionality for the data sources 64, as well as audio sources 62, might be implemented on a single or unitary device 30, which includes suitable radio components, cellular network components, or wireless network components for accessing various cellular or wireless networks. In that embodiment, the single device 30 might operate as a plurality of different radio devices coupled to any number of other different remote radio devices for two-way voice communications. Similarly, device 30 might act as a cellular device, such as a cellular telephone, for making calls and transceiving data within a cellular network. Still further, through the WLAN connection, device 30 might act as a portable computer for interfacing with other computers and networked components through an appropriate wireless network. As such, the present invention has applicability for controlling and interfacing with a plurality of separate devices utilizing user speech, or with a single component, which has the consolidated functionality of various different devices.

In one embodiment of the present invention, the user is able to configure their audio listening environment so that the various different audio inputs, whether a real human voice or synthesized voice, have certain output and input characteristics. Furthermore, a user 60 is able to prioritize one or more external audio sources 62 or applications 64 as the primary or foreground audio source. Still further, utilizing human speech in accordance with the principles of the present invention, a user may select a particular destination for their speech, from among the various applications or external audio sources. For example, when a user speaks, they may want to direct the audio of their spoken utterances or speech back to one particular selected radio. Alternatively, the data associated with a response provided in user speech might be meant for one or more particular applications. In accordance with the principles of the invention, the user speech from user 60 may be utilized to select not only the primary audio that the user hears, but also the primary destination for user speech.

Turning to FIG. 3, the present invention utilizes an audio mixer/controller 44 indicated in FIG. 3 as audio foreground/background mixer and volume control. The component 44 and the functionality thereof may be implemented in a combination of hardware and software for providing the desired control of the audio sources, as well as the features or characteristics of those audio sources, such as volume. For example, the functionality of component 44 might be implemented on a suitable processor in device 30. In accordance with one aspect of the invention, the user 60 may speak and such speech will be captured by a microphone 52. The user speech is indicated in FIG. 3 by reference numeral 72. The user's speech captured by a microphone 52 is directed to the speech recognition (TTS) functionality or component 40 of device 30. Spoken words of the user are then recognized. Next, a determination is made of whether the user's recognized speech includes one or more command key words or phrases. A voice-controlled context switch functionality or component 42 is used to determine the particular destination of the user's speech 72. Certain command phrases or key words are recognized, and the context switch 42 is controlled, such as according to the executive system application 66, to direct the audio of the user's speech to a particular external audio source 62. In that way, the user's speech may be directed to an appropriate audio source 62, such as to engage in a speech dialog with another person on another radio. In such a case, once an external audio source is chosen as a destination, the speech of the user would be directed as audio to that audio source 62 rather than as data that is output from a speech recognition application 40. Alternatively, the output of the speech recognition application 40 might be sent as data to a particular application 64 to provide input to that application. Alternatively, the context switch 42 might select the executive system application as the desired destination for data associated with the user's speech that is recognized by application 40. The destination will determine the use for the user speech, such as whether it is part of a two-way conversation (and should not be further recognized with application 40), or whether the speech is used to enter data or otherwise control the operation of the present invention, and should be subject to speech recognition.

The spoken speech 72 from user 60 might also include command words and phrases that are utilized by the executive system application 66 and audio mixer/controller 44 in order to select what audio source 64 is the primary audio source to be heard by user 60, as indicated by reference numeral 74. For example, utilizing the speech recognition capabilities of the invention and the voice interface that is provides, a user may be able to use speech to direct the invention to select one of the different audio streams 76 as the primary or foreground audio to be heard by user 60. This may be implemented by the audio mixer/controller 44, as controlled by the executive system application 66. For example, if the user wants to primarily hear the input from a particular external radio audio source, such as radio audio source (34), that particular audio stream from a series of external audio inputs 62 is selected as the foreground or primary audio input to speaker 50 through the control of audio mixer/controller 44. When an input audio stream is selected as the foreground application, it is designated as such and configured so that the user can tell which source is the primary source. For example, the volume level of the primary or foreground audio stream is controlled to be higher than the other audio sources 76 to indicate that it is a foreground or primary audio application. Alternatively, other audio cues might be used. For example, a prefix beep, a background tone, specific sound source directionality/spatiality, or some other auditory means could also be used to indicate the primary channel to the user. Such mixer control, volume control and audio configuration/designation features might be provided by the audio mixer/controller component 44 to implement the foreground or primary audio source as well as the various background audio sources.

In accordance with another aspect of the present invention, the other audio sources, such as spoken audio 62, or synthesized audio from one or more of the applications 64 might also be heard, but will be maintained in the background. Alternatively, when an audio source is selected as the primary source, all other inputs 76 might be effectively muted.

In one embodiment, when a particular audio source or application is selected to be in the foreground, it is also selected as the destination for any output speech 72 from a user. Therefore, the output speech 72 from a user is channeled specifically to the selected primary audio source device or application by default. For example, in a two-way radio dialog between user 60 and another person, when the user hears audio from a radio 34, 36, they will want them to respond to that radio as well. However, utilizing the voice-controlled context switch 42 and command phrases, a different application or audio source might be selected as the destination for user speech output 72. As noted above, if the user 60 is carrying on a two-way conversation through a radio 34, 36, and is hearing audio speech from another person, generally the spoken speech output 72 from the user would be directed back to that radio 34, 36 in response to the two-way conversation. As such, the destination would to that same radio where the audio input 74 is coming from. Alternatively, based upon something heard through the audio input 74 from the radio 34, 36, the user 60 may desire to select another destination, such as one of the applications 64, in order to access information from a database, for example. To that end, the user might speak a particular command word/phrase, and the context switch 42 may then switch the output speech 72 to a separate destination, such as application 1 illustrated in FIG. 3. Then, utilizing the speech recognition and TTS functionality 40 of the invention, the user speech 72 is recognized, and data might be provided to Application 1, and suitable output data would result. The output data would then be appropriately synthesized into a voice input to be heard by user 60 through the appropriate TTS voice functionality 68, such as TTS voice 1, as illustrated in FIG. 3. That voice source would then be directed back to the user through the audio mixer/controller 44. In that way, the dialog might be maintained with Application 1 or various of the other Applications indicated collectively as 64.

The executive system application 66 provides control of the voice context switch functionality 42 and the audio mixer/controller functionality 44, and is responsive to various system command words/phrases and is operable to provide the necessary configuration and characteristics of the other system functions. For example, the output speech 72 might be directed to the executive system application 66 to configure features of the invention, such as through operation of the context switch 42 and the audio mixer/controller 44. The executive system application 66 has its own voice provided by an appropriate TTS functionality 70. The particular volume levels or other audio characteristics for each of the audio or voice inputs 76 may be controlled by voice or speech through the executive system application. This allows the user to control and distinguish between the multiple audio streams 76, and therefore, provides a particular indication to the user of what sources are providing which audio streams.

Another feature of the present invention is the user of virtual audio effects that are provided through the audio mixer/controller 44 as configured by the executive system application 66 and speech commands 72 of the user. The audio mixer/controller 44 and its functionality may be utilized to provide a perceived spatial offset or spatial separation between the audio inputs 76, such as a perceived front-to-back spatial separation, or a left-to-right spatial separation to each of the audio inputs 76. Through the use of speech commands 72 and the executive system application 66, the audio mixer/controller can be configured to provide the user the desired spatial offset or separation between the audio sources 76 so that they may be more readily monitored and selected. This allows the user 60 to control their interface with multiple different information and audio sources.

Similarly, the present invention provides clues by way of live voices and synthesized or TTS voices in order to help a user distinguish between the various audio sources. While live voices will be dictated by the person at the other end of a two-way radio link, the various TTS voice functionality 68 provided for each of the applications 64 might be controlled and selected through the executive system application and the voice commands of the user. For example, in one particular application, the interface to a law enforcement database, might be selected to have a synthesized voice of a man. Alternatively, the audio from a GPS functionality associated with one of the applications 64 might have a synthesized female voice. In that way, the user may hear all of the various audio sources 76, and will be able to distinguish that one audio stream is from one application, while another audio stream is from another different application. In an alternative embodiment, each of the applications might include a separate prefix tone or background tone or other audio tone so that the audio sources, such as a particular radio or GPS application for example, might be determined and distinguished. The user would know what the source is based on a tone or audio signal heard that is associated with that source.

Accordingly, the present invention provides various advantages utilizing a speech interface for control of multiple different audio sources. The present invention minimizes the confusion for users that are required to process and take action with respect to multiple audio sources or to otherwise multitask with various different components that include live voice as well as data applications. Furthermore, the invention allows a user to select certain target output destinations to receive the user's speech 72. The invention also allows a user to directly control which audio sources are to be heard as foreground and background via an audio mixer/controller 44 that is controlled utilizing user speech. The present invention also helps the user to distinguish multiple audio streams through various user clues, such as different TTS voices, live voices, audio volume, specific prefix tones and perceived spatial offset or separation between the audio streams.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A speech-directed user interface system comprising:
at least one speaker for delivering an audio signal to a user and at least one microphone for capturing speech utterances of a user;
an interface device for interfacing with the speaker and microphone and providing a plurality of different audio signals to the speaker to be heard by the user;
a control circuit operably coupled with the interface device and configured for selecting at least one of the plurality of audio signals as a foreground audio signal for delivery to the user through the speaker, the control circuit operable for recognizing speech utterances of a user and using the recognized speech utterances to control the selection of the foreground audio signal.

2. The speech-directed user interface system of claim 1 wherein the interface device provides a plurality of audio signals that include at least one of a natural human speech signal and a synthesized speech signal.

3. The speech-directed user interface system of claim 1 further comprising a radio device operably coupled with the interface device to provide an audio signal.

4. The speech-directed user interface system of claim 1 further comprising a processing device operably coupled with the interface device to provide an audio signal.

5. The speech-directed user interface system of claim 4 wherein the processing device includes a text-to-speech component for generating a synthesized speech signal.

6. The speech-directed user interface system of claim 1 wherein the interface device includes a plurality of selectable outputs for outputting the captured speech utterances of the user and the control circuit is configured for selecting at least one of the plurality of outputs for directing captured user speech utterances, the control circuit operable for recognizing speech utterances of a user and using the recognized speech utterances to control the selection of an output for captured speech utterances.

7. The speech-directed user interface system of claim 6 wherein at least one of the outputs includes a radio device.

8. The speech-directed user interface system of claim 6 wherein at least one of the outputs includes a processing device.

9. The speech-directed user interface system of claim 1 wherein the control circuit is contained in the interface device.

10. The speech-directed user interface system of claim 3 wherein the radio device is contained in the interface device to provide an audio signal.

11. The speech-directed user interface system of claim 4 wherein the processing device is contained in the interface device to provide an audio signal.

12. The speech-directed user interface system of claim 1 wherein the control circuit selects a foreground audio signal by changing the volume of that audio signal with respect to at least another of the plurality of audio signals.

13. The speech-directed user interface system of claim 1 wherein the control circuit selects a foreground audio signal by changing the spatial separation of that audio signal with respect to at least another of the plurality of audio signals.

14. The speech-directed user interface system of claim 1 wherein the control circuit selects a foreground audio signal by selecting a particular text-to-speech application for that audio signal with respect to at least another of the plurality of audio signals.

15. The speech-directed user interface system of claim 1 wherein the control circuit selects a foreground audio signal by providing at least one of a prefix tone, a background tone or other audio tone associated with the foreground audio signal.

16. The speech-directed user interface system of claim 1 wherein the interface device includes a network link component for linking to a remote device through a network.

17. A method of interfacing with a user with speech comprising:
delivering an audio signal to the user with at least one speaker and capturing speech utterances of a user with at least one microphone;
using an interface device for interfacing with the speaker and microphone and providing a plurality of different audio signals to the speaker to be heard by the user;
selecting, through the interface device, at least one of the plurality of different audio signals as a foreground audio signal for delivery to the user through the speaker.
recognizing speech utterances of the user and using the recognized speech utterances to control the selection of the foreground audio signal.

18. The method of claim 17 further comprising providing a plurality of audio signals that include at least one of a natural human speech signal and a synthesized speech signal.

19. The method of claim 17 further comprising using a radio device, operably coupled with the interface device, to provide an audio signal.

20. The method of claim 17 further comprising using a processing device, operably coupled with the interface device, to provide an audio signal.

21. The method of claim 20 wherein the processing device includes a text-to-speech component for generating a synthesized speech signal.

22. The method of claim 17 wherein the interface device includes a plurality of selectable outputs for outputting the captured speech utterances of the user and further comprising selecting at least one of the plurality of outputs for directing captured user speech utterances.

23. The method of claim 22 wherein at least one of the outputs includes a radio device.

24. The method of claim 22 wherein at least one of the outputs includes a processing device.

25. The method of claim 17 further comprising selecting a foreground audio signal by changing the volume of that audio signal with respect to at least another of the plurality of audio signals.

26. The method of claim 17 further comprising selecting a foreground audio signal by changing the spatial separation of that audio signal with respect to at least another of the plurality of audio signals.

27. The method of claim 17 further comprising selecting a foreground audio signal by selecting a particular text-to-speech application for that audio signal with respect to at least another of the plurality of audio signals.

28. The method of claim 17 further comprising selecting a foreground audio signal by providing at least one of a prefix tone, a background tone or other audio tone associated with the foreground audio signal.

29. The method of claim 17 further comprising linking to a remote device through a network.
